(19) United States
(12) Patent Application Publication
(10) Pub. No.: US 2008/0300970 A1
(43) Pub. Date: Dec. 4, 2008

(54) REDEMPTION TECHNIQUES FOR ELECTRONIC COUPONS

(75) Inventor: Bernd Scheibe, Hamburg (DE)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/754,548

(22) Filed: May 29, 2007

(51) Int. Cl. G06Q 30/00

(52) U.S. Cl. 705/14

(57) ABSTRACT

Methods and apparatus are described for redeeming an electronic coupon. The electronic coupon corresponds to an advertiser and has an associated coupon identifier. The coupon identifier is received as part of a first communication session with a communication device. Redemption of the electronic coupon is facilitated where the communication device is associated with the advertiser.

### BACKGROUND OF THE INVENTION

The present invention relates to electronic coupons and, in particular to techniques for facilitating redemption of electronic coupons relating to small businesses having minimal technological infrastructure.

Electronic coupons issued over the Web or mobile device networks are an increasingly common tool in targeted advertising. One barrier to the use of electronic coupons for small, local businesses is the infrastructure typically required to facilitate redemption and tracking. That is, it is relatively easy to issue electronic coupons to consumers given that most consumers have some way of connecting to the Web or a mobile device network. And such coupons may be readily redeemed by large online and brick-and-mortar businesses using the infrastructure typically inherent in such organizations. However, small, local businesses often have little or no infrastructure that allows them to easily employ such marketing tools.

### SUMMARY OF THE INVENTION

According to various specific embodiments of the present invention methods and apparatus are provided for redeeming an electronic coupon. The electronic coupon corresponds to an advertiser and has an associated coupon identifier. The coupon identifier is received as part of a first communication session with a communication device. Redemption of the electronic coupon is facilitated where the communication device is associated with the advertiser.

According to additional embodiments, methods and apparatus are provided for redeeming an electronic coupon. The electronic coupon corresponds to an advertiser and has an associated coupon identifier. A first phone number corresponding to a communication device associated with the advertiser is provided to a coupon redemption system. The coupon identifier is transmitted as part of a first communication session between the communication device and the coupon redemption system. The electronic coupon is redeemed where the coupon redemption system indicates the electronic coupon to be valid.

A further understanding of the nature and advantages of the present invention may be realized by reference to the remaining portions of the specification and the drawings.

### BRIEF DESCRIPTION OF THE DRAWINGS

FIG. 1 is a flowchart illustrating interaction between an advertiser and a coupon redemption system according to a specific embodiment of the invention.

FIG. 2 is a flowchart illustrating interaction between a consumer and a coupon redemption system according to a specific embodiment of the invention.

FIG. 3 is a diagram illustrating a network environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Large businesses typically have the infrastructure which can be easily adapted to redeem electronic coupons. Coupon codes can be easily entered via keyboards, scanners, bar code readers, etc. However, many small businesses do not have such an infrastructure. On the other hand, most small businesses have one or more phones, e.g., either land lines or mobile devices. Therefore, embodiments of the present invention take advantage of this fact and employ phones and similar devices to redeem electronic coupons.

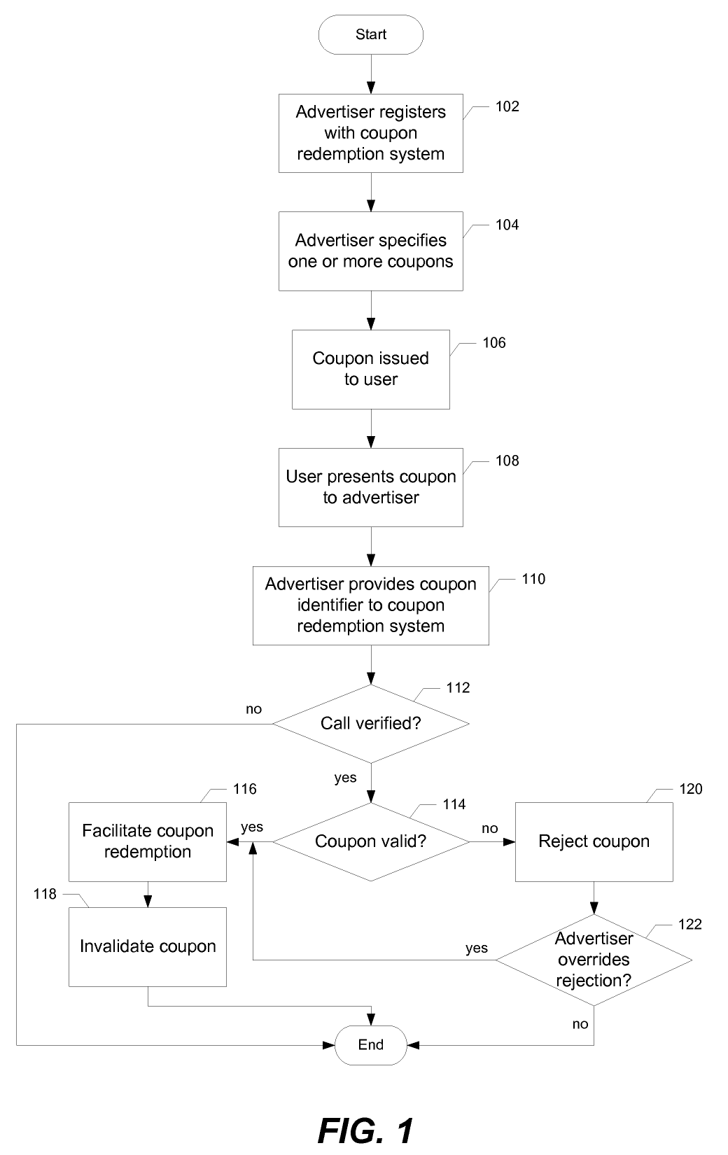

Referring now to FIG. 1, operation of a coupon redemption system implemented in accordance with a specific embodiment of the invention will be described. An advertiser (which may be, for example, a local business), registers with the system (102). According to a particular implementation, this involves the advertiser providing one or more phone numbers to the system. The phone number(s) may correspond to any of a variety of communication devices such as, for example, conventional land lines, mobile devices (e.g., cellular phones, smart phones, etc.), IP phones, etc.

Once registered with the system, the advertiser may specify one or more coupons for electronic distribution by the system (104). According to various embodiments, this will typically involve the advertiser specifying the terms of such coupons including, for example, business rules according to which distribution and redemption of the coupons are to be facilitated. For example, the advertiser might specify that all users conducting a search using one or more specific keywords in a particular geographic area (e.g., a zone defined by the location of the advertiser's business) be presented with a coupon for a specified percentage off particular goods or services. More generally, virtually any technique by which a coupon may be generated and distributed may be employed with various embodiments of the invention.

When a user triggers the advertiser's business rules, a coupon is issued to the user by the coupon redemption system (106). As indicated above, this might occur in the context of an online search being conducted by the user of a mobile device, e.g., based on specific keywords and the user's location (e.g., as determined by proximity to a mobile phone cell, a GPS system, IP address, etc.) the advertiser's specified business rules result in presentation of the coupon on the user's device. Alternatively, the user might be operating a desktop computer, receive the coupon there, and subsequently transfer the coupon to a mobile device or even print out the coupon for redemption at the advertiser's place of business.

According to specific embodiments of the invention, the coupon has an associated identifier which is related in the system to the advertiser, e.g., by associating the identifier with the advertiser's phone number(s). According to some of these embodiments, the combination of the identifier and the advertiser is unique in the system, while the identifier alone may not be unique (e.g., another advertiser might issue a coupon with the same identifier). In such an embodiment, a single user could potentially hold two coupons from two different advertisers having the same identifier. In such a case, the user would refer to other indicia associated with the coupon, e.g., text in an SMS message, to identify which advertiser is associated with each. And as will be discussed below, the coupon identifier may also be related in the system to the user to whom it was issued, e.g., by associating the coupon identifier with the user's phone number. However, it should be understood that such a relationship between the coupon identifier and the user does not need to be maintained.

According to some of these embodiments, the coupon identifier is a relatively small string of characters, e.g., fewer than 10. This may be advantageous where, for example, the coupon is sent to the user via a mechanism such as SMS (Short Message Service) in which the number of characters allowed in a message is relatively small, e.g., fewer than 160 characters. That is, it is desirable to save a sufficient number of characters for describing the coupon terms. It is also much easier for a representative of the advertiser to see and remember or make a note of the identifier when it contains relatively few characters.

In addition, a small identifier may be advantageous where the identifier is to be incorporated into or associated with (e.g., as an extension to) a phone number for redemption purposes as discussed below. Moreover, such redemption methods could be further facilitated by limiting the characters to numeric characters (i.e., entering and distinguishing specific alpha characters on a conventional phone presents difficulties). However, notwithstanding the foregoing, it will be understood that, in general, coupon identifiers used with embodiments of the invention are not necessarily limited in these ways.

Referring once again to FIG. 1, when the user wishes to redeem the coupon, the user presents the coupon identifier at the advertiser's place of business (108). According to various embodiments, this presentation may take a variety of forms. For example, in an implementation in which the coupon is issued to the user via an SMS message, the user may simply show the coupon identifier to a representative of the advertiser (e.g., a waiter or cashier) on the screen of the user's mobile device. Alternatively, if the user received the coupon on his desktop, he may print it out and bring it to the advertiser's place of business. As will be appreciated, the coupon and/or its associated identifier may be presented to the advertiser in any of a wide variety of ways without departing from the scope of the invention.

Regardless of how the coupon identifier is presented to the advertiser, the advertiser's representative effects redemption by initiating a communication session, e.g., making a phone call, in which the coupon identifier is transmitted to the coupon redemption system (110). According to a specific embodiment, the coupon identifier is all or part of a phone number entered by the advertiser's representative. That is, for example, the coupon identifier could be a complete phone number, e.g., 1-800-555-1234, or just some part of the number, e.g., the last 4 digits. Alternatively, the coupon identifier could be distinct from the number called and could be entered at some point during the call (e.g., in response to a voice prompt or as an extension).

According to various specific embodiments, before redemption occurs, the call may be verified by the coupon redemption system as coming from an authorized representative of the advertiser (112). This verification may be accomplished in a variety of ways without departing from the invention. For example, the phone number from which the redemption call is received (e.g., as determined using caller ID) could be compared against the phone number(s) stored for the advertiser as part of the registration process. Alternatively, if the phone number from which the redemption call is received cannot be identified (e.g., access to that information is restricted in some way), the caller may be prompted (e.g., using an automated voice system) to enter a password or an identification number corresponding to the advertiser (e.g., the advertiser's phone number). According to some embodiments, the requested password or ID number may be different than the advertiser's phone number to protect against fraud.

In addition, embodiments are contemplated in which the advertiser is associated with some identifier other than a conventional phone number which may be used to effect call verification. For example, in the mobile space, each mobile device has a mobile ID number or MIN which is unique and may be used for this purpose. Similarly, in the voice-over-IP context, MAC or IP addresses might be used. Regardless of the mechanism by which the call is verified, a powerful mechanism against fraud is provided because the system can obtain some assurance that it is the advertiser (or an authorized representative) who is requesting redemption of the coupon.

Once the call is verified, the coupon redemption system determines whether the coupon identifier corresponds to a valid coupon for that advertiser (114). If so, the coupon is redeemed (116). Once redeemed, a coupon may be invalidated (118) by the coupon redemption system to avoid subsequent attempts to redeem the same coupon. If the call cannot be verified, or the coupon is determined not to be valid, the coupon is rejected (120).

According to some embodiments, redemption or rejection involves communicating the results of the redemption attempt to the advertiser's representative as part of the redemption phone call. This may be achieved, for example, with an automated voice response to the advertiser's phone indicating whether or not the coupon has been successfully redeemed. Alternatively, such a message could be communicated as a text message (e.g., an SMS message) to the advertiser's phone.

According to a specific embodiment, even where a coupon is indicated to the advertiser as being invalid, the advertiser's representative may still want to allow redemption of the coupon. In such a case, the advertiser's representative may be given the option to override the rejection of the coupon (122), e.g., by entering one or more key strokes or voice responses, in response to which, redemption of the coupon is effected (116).

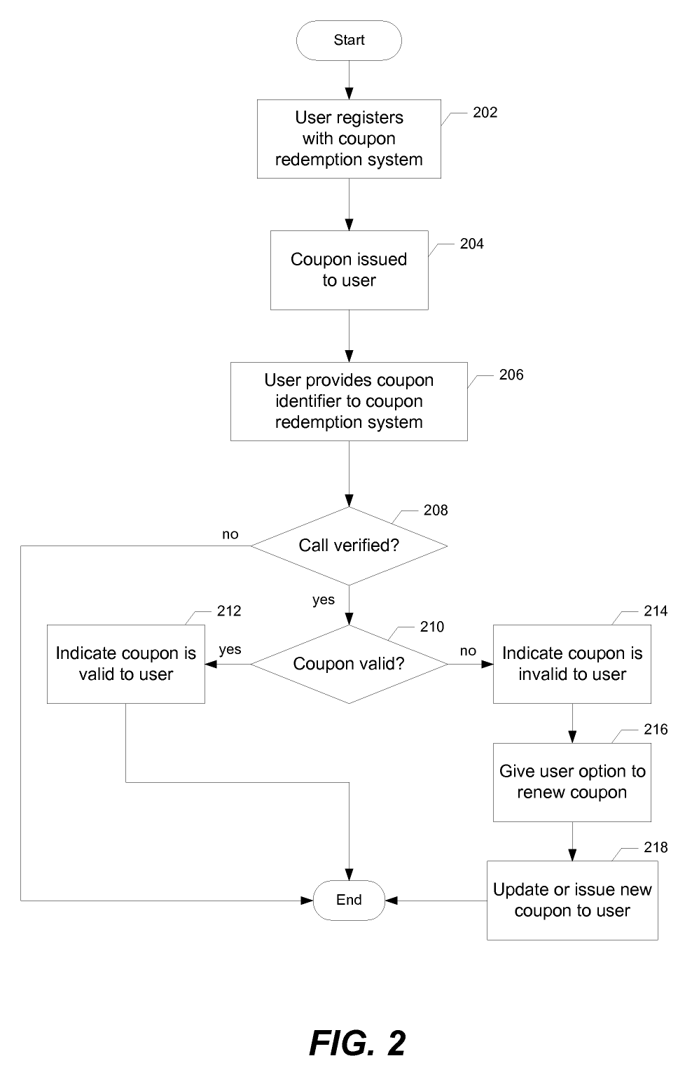

According to one set of embodiments, an example of which is illustrated in FIG. 2, a user (e.g., a consumer who wishes to take advantage of a coupon redemption system designed in accordance with such embodiments) registers with the system (202). According to a particular implementation, this involves the user providing at least one phone number to the system which may correspond, for example, to virtually any type of mobile device (e.g., a cellular phone, a smart phone, etc.).

It should be noted that such registration is not necessary to effect redemption of coupons in accordance with some embodiments of the invention. However, such registration may be advantageous for a variety of reasons. For example, registration could be a precondition to receiving such coupons in the first place. In addition, registration may be used to facilitate providing a range of services to the user in connection with electronic coupons including, for example, services relating to the organization and management of such coupons.

According to a specific embodiment, and referring once again to FIG. 2, when the user satisfies one or more conditions or triggers some event (e.g., as represented by an advertiser's business rules), a coupon is issued to the user (204). As will be understood, presentation of the coupon to the user may be achieved in a variety of ways depending on the context in which the conditions are satisfied or the event occurs. For example, if the user is browsing the Web, the coupon could be transmitted as an object embedded in a web page. Alternatively, if the user is on a mobile device, e.g., a cellular phone, the coupon identifier could be transmitted to the device as part of a text message. A wide variety of other suitable mechanisms will be apparent to those of skill in the art.

In addition and as mentioned above, issuance of the coupon may involve relating the coupon identifier associated with the coupon to the user with reference, for example, to the user's phone number. Then, at some subsequent point in time when the user is interested in redeeming the coupon, the user may determine whether the offer embodied by the coupon is still valid by initiating a communication session, e.g., making a phone call, in which the coupon identifier is transmitted to the coupon redemption system (206). According to a specific embodiment in which the coupon identifier is included in a phone number, the user simply initiates a call to that phone number.

The call may be verified by the coupon redemption system as coming from the user to whom the coupon corresponding to the identifier was issued (208). As with the example redemption flow described above, this verification may be achieved in a variety of ways such as, for example, determining whether the coupon identifier maps to the phone number of the device from which the user's call originated. And once the call is verified, the coupon redemption system determines whether the coupon identifier corresponds to a valid coupon (210). The results of this determination are then communicated to the user as part of the phone call, i.e., the coupon is indicated as valid (212) or invalid (214). As with the redemption flow, this communication may be achieved in any of a variety of ways. In embodiments in which the user might have multiple coupons with the same coupon identifier, the system may determine and communicate the validity of all coupons having that identifier. Alternatively, the user could be prompted to provide additional information, e.g., the advertiser's name or other relevant coupon terms, to uniquely identify the coupon for which a validity determination is desired.

According to a specific embodiment, the business rules specified by the advertiser may allow any user or only specified users to be issued new or updated coupons where offers are determined to be no longer valid. Thus, in the example of FIG. 2, where the coupon is determined or indicated to be invalid, the user may be given the option to request a new or updated version of the coupon (216) by taking appropriate action (e.g., by entering one or more key strokes or voice responses), in response to which the coupon redemption system may issue a new or updated coupon (218). Alternatively, advertiser's business rules could be such that the issuance of the new or updated coupon occurs automatically.

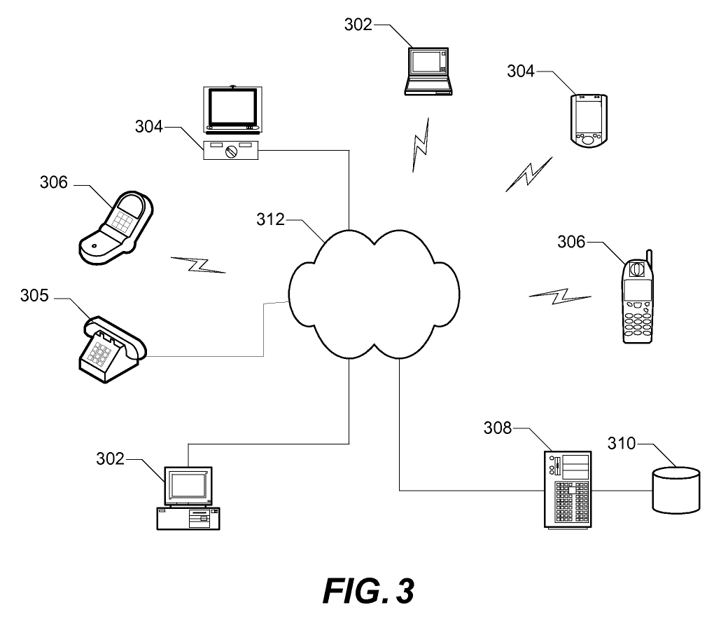

It should be noted that various aspects of the present invention may be implemented using any of a wide variety of communication devices and computing platforms, in any of a variety of network types (or combinations thereof), and in any of a wide variety of contexts in which the issuance and redemption of electronic coupons are useful functionalities. For example and as illustrated in FIG. 3, implementations are contemplated in which electronic coupons may be issued and/or redeemed, and users and advertisers may interact with a coupon redemption system using personal computers 302, media computing platforms 303 (e.g., gaming platforms, or cable and satellite set top boxes with navigation and recording capabilities), handheld computing devices (e.g., PDAs) 304, conventional land lines 305 (wired and wireless), mobile (e.g., cell or smart) phones 306, or any other type of portable communication or computing platform (e.g., vehicle navigation systems). Such coupons may be resident on some of these devices, e.g., in connection with a browser, messaging, or other application, or be served up from a remote site, e.g., in a web page or a messaging application. In addition, a coupon redemption system (represented by server 308 and data store 310) may be accessible to the various types of devices either directly or indirectly via a wide variety and/or combination of network environments and protocols (represented by network 312) including, but not limited to, TCP/IP-based networks, plain old telephone system (POTS) networks, telecommunications networks, wireless networks, satellite networks, etc. There might also be 3^{rd} party coupon redemption systems are also contemplated which might issue coupons using APIs to access the relevant data.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein with reference to the use of conventional land lines and cellular phones. It will be understood, however, that the invention is not so limited. That is, embodiments are contemplated in which a much wider diversity of communication devices may be employed in various combinations to effect coupon redemption.

In addition and although the present invention is particularly advantageous for enabling small local, “brick-and-mortar” businesses to employ coupons to attract geographically proximate consumers, the techniques described herein are not necessarily limited to such implementations. For example, embodiments are contemplated in which the advertiser is an online business or individual for whom the ease of coupon redemption over the phone would be useful, e.g., a seller on an online auction site.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for redeeming an electronic coupon, the electronic coupon corresponding to an advertiser and having an associated coupon identifier, the method comprising:
receiving the coupon identifier as part of a first communication session with a communication device; and
facilitating redemption of the electronic coupon where the communication device is associated with the advertiser.

2. The method of claim 1 further comprising issuing the electronic coupon to a consumer by transmitting the coupon identifier to a mobile device associated with the consumer.

3. The method of claim 2 further comprising:
receiving the coupon identifier as part of a second communication session with the mobile device; and
communicating whether the electronic coupon is valid to the consumer via the mobile device.

4. The method of claim 3 further comprising issuing a new electronic coupon to the consumer where the electronic coupon is invalid.

5. The method of claim 2 wherein transmitting the coupon identifier to the mobile device is accomplished using an SMS message.

6. The method of claim 1 further comprising determining whether the communication device is associated with the advertiser with reference to a mapping between the advertiser and a phone number associated with the communication device.

7. The method of claim 1 further comprising determining whether the communication device is associated with the advertiser by requesting an advertiser identifier during the first communication session.

8. The method of claim 1 wherein the first communication session with the communication device is initiated by the communication device with a phone number which includes the coupon identifier.

9. The method of claim 1 further comprising registering the advertiser by associating a first phone number corresponding to the communication device with the advertiser, and registering the consumer by associating a second phone number corresponding to a mobile device with the consumer, the method further comprising associating the coupon identifier with the first and second phone numbers.

10. The method of claim 1 further comprising determining whether the electronic coupon is valid, wherein facilitating redemption of the coupon comprises indicating that the coupon is valid as part of the first communication session.

11. A computer program product for redeeming an electronic coupon, the electronic coupon corresponding to an advertiser and having an associated coupon identifier, the computer program product comprising at least one computer readable medium having computer program instructions stored therein, the computer program instructions being configured to cause at least one computer to:
receive the coupon identifier as part of a first communication session with a communication device; and
facilitate redemption of the electronic coupon where the communication device is associated with the advertiser.

12. The computer program product of claim 11 wherein the computer program instructions are further configured to cause the at least one computer to issue the electronic coupon to a consumer by transmitting the coupon identifier to a mobile device associated with the consumer.

13. The computer program product of claim 12 wherein the computer program instructions are further configured to cause the at least one computer to:
receive the coupon identifier as part of a second communication session with the mobile device; and
communicate whether the electronic coupon is valid to the consumer via the mobile device.

14. The computer program product of claim 13 wherein the computer program instructions are further configured to cause the at least one computer to issue a new electronic coupon to the consumer where the electronic coupon is invalid.

15. The computer program product of claim 12 wherein transmitting the coupon identifier to the mobile device is accomplished using an SMS message.

16. The computer program product of claim 11 wherein the computer program instructions are further configured to cause the at least one computer to determine whether the communication device is associated with the advertiser with reference to a mapping between the advertiser and a phone number associated with the communication device.

17. The computer program product of claim 11 wherein the computer program instructions are further configured to cause the at least one computer to determine whether the communication device is associated with the advertiser by requesting an advertiser identifier during the first communication session.

18. The computer program product of claim 11 wherein the first communication session with the communication device is initiated by the communication device with a phone number which includes the coupon identifier.

19. The computer program product of claim 11 wherein the computer program instructions are further configured to cause the at least one computer to register the advertiser by associating a first phone number corresponding to the communication device with the advertiser, and register the consumer by associating a second phone number corresponding to a mobile device with the consumer, the computer program instructions being further configured to cause the at least one computer to associate the coupon identifier with the first and second phone numbers.

20. The computer program product of claim 19 wherein the computer program instructions are further configured to cause the at least one computer to determine whether the electronic coupon is valid, and to facilitate redemption of the coupon by indicating that the coupon is valid as part of the first communication session.

21. A method for redeeming an electronic coupon, the electronic coupon corresponding to an advertiser and having an associated coupon identifier, the method comprising:
providing a first phone number corresponding to a communication device associated with the advertiser to a coupon redemption system;
transmitting the coupon identifier as part of a first communication session between the communication device and the coupon redemption system; and
redeeming the electronic coupon where the coupon redemption system indicates the electronic coupon to be valid.

22. The method of claim 21 further comprising specifying terms to the coupon redemption system according to which the electronic coupon is generated.

23. The method of claim 21 further comprising providing an advertiser identifier corresponding to the advertiser during the first communication session.

24. The method of claim 21 further comprising initiating the first communication session by entering a second phone number which includes the coupon identifier.
